(19) United States
(12) Patent Application Publication
(10) Pub. No.: US 2014/0136742 A1
(43) Pub. Date: May 15, 2014

(54) COMMUNICATION SYSTEM

(71) Applicant: DENSO CORPORATION, Kariya-city (JP)

(72) Inventors: Hirokazu OOYABU, Nagoya-city (JP); Hideaki ISHIHARA, Okazaki-city (JP); Akira TAKAOKA, Okazaki-city (JP)

(73) Assignee: DENSO CORPORATION, Kariya-city (JP)

(21) Appl. No.: 14/078,681

(22) Filed: Nov. 13, 2013

(30) Foreign Application Priority Data
Nov. 15, 2012 (JP) 2012-251348

(51) Int. Cl. G06F 13/364

(52) U.S. Cl. CPC G06F 13/364
USPC 710/110

(57) ABSTRACT

A communication system includes: a master device; and slave devices communicating with the master device via a transmission line. The master device includes: an electric power supply unit for outputting an electric power supply signal having one specific frequency to the transmission line; a master communication unit for communicating with each slave device through a communication signal; and an electric power supply frequency setting unit for setting the one specific frequency. Each slave device includes: an electric power supply signal input and output unit for retrieving the electric power supply signal having a set frequency from the transmission line; a communication signal input and output unit for receiving and transmitting the communication signal to the transmission line; a slave communication unit for communicating with the master device through the communication signal; and a power source for energizing the slave communication unit according to the electric power supply signal.

### CROSS REFERENCE TO RELATED APPLICATION

This application is based on Japanese Patent Application No. 2012-251348 filed on Nov. 15, 2012, the disclosure of which is incorporated herein by reference.

### TECHNICAL FIELD

The present disclosure relates to a communication system including a master device and a slave device, which are communicated with each other via a transmission line.

### BACKGROUND

In a communication system for communicating between multiple devices via a common transmission line, conventionally, it is well known that the same transmission line such as a bus line is used for transmitting and receiving signals (i.e., data) for communication and further for supplying electricity in order to reduce the number of wirings. In this type of the communication system, the communication and the energization via a power feeding line are performed without contacting the power feeding line. This technique is disclosed in, for example, JP-A-H10-84303 (corresponding to U.S. Pat. No. 6,005,475).

The communication system disclosed in JP-A-H10-84303 is applied to a carrier device that moves along a rail arranged on a ceiling. An alternating current electric power is supplied to the carrier device via the power feeding line, which is arranged along the rail. Further, the carrier device includes an antenna, which faces the power feeding line. Thus, the carrier device executes the energization and the communication via the antenna with the power feeding line without contacting the power feeding line.

In the above system, all of the carrier devices are energized always. Specifically, even when only a part of the carrier devices are required to move according to situation, all of the carrier devices are energized. Thus, excess electric power is consumed. Specifically, when the system is applied to a vehicular communication system having an electric power source of a battery, it is required to reduce energy consumption as much as possible in order to operate the system for a long time.

### SUMMARY

It is an object of the present disclosure to provide a communication system for communicating between multiple devices via a transmission line with low electric power consumption.

According to an example aspect of the present disclosure, a communication system includes: a master device; and a plurality of slave devices, each of which communicates with the master device via a transmission line. The master device includes: an electric power supply unit for selecting one of a plurality of specific frequencies, each of which is associated with one or more slave devices, and for outputting an electric power supply signal having the one of the specific frequencies to the transmission line; a master communication unit for communicating with each slave device via the transmission line through a communication signal having a predetermined communication frequency; and an electric power supply frequency setting unit for setting the one of the specific frequencies, which corresponds to a communication object slave device as a communication object of the master communication unit. Each slave device includes: an electric power supply signal input and output unit for retrieving the electric power supply signal having a set frequency from the transmission line without contacting the transmission line, the set frequency being defined by a corresponding one of the specific frequencies associated with the slave device; a communication signal input and output unit for receiving and transmitting the communication signal to the transmission line without contacting the transmission line; a slave communication unit for communicating with the master device through the communication signal; and a power source for energizing the slave communication unit according to the electric power supply signal, which is retrieved by the electric power supply signal input and output unit.

In the above communication system, only the slave device having the set frequency equal to the one of the specific frequencies in the electric power supply signal is energized, so that the slave communication unit in the slave device functions. Accordingly, the system restricts the energization to slave devices other than the communication object slave device, which is not necessary to be energized. Thus, energy consumption in a whole of the communication system is reduced. Further, in the communication system, each slave device is electrically coupled with the transmission line without contacting the transmission line. Accordingly, each slave device is arranged near the transmission line without contacting the transmission line. Thus, the reliability of the communication system is improved, and further, the arrangement degree of freedom between the slave devices and the transmission line is increased.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a communication system according to a first embodiment;

FIG. 2 is a diagram showing a command frame;

FIG. 3 is a block diagram showing a master device and a slave device;

FIG. 4 is a flowchart showing a master communication process;

FIGS. 5A to 5C are diagrams showing signals generated in the master device, FIG. 5A shows a command frame, FIG. 5B shows a power feeding signal, and FIG. 5C shows a part of the power feeding signal and a communication signal prepared by modulating the power feeding signal with the command frame;

FIG. 6 is a diagram showing a transmission efficiency of the power feeding signal in a connection circuit unit;

FIG. 7 is a diagram showing operations of the master device and the slave devices when the master device communicates with the first slave device, and successively, communicates with the second slave device;

FIG. 8 is a block diagram showing a communication system according to a second embodiment;

FIG. 9 is a block diagram showing a connection circuit unit;

FIG. 10 is a diagram showing a transmission efficiency of the power feeding signal in the connection circuit unit;

FIG. 11 is a diagram showing operations of the master device and the slave devices when the master device changes a set frequency of the first slave device from the first specific frequency to the second specific frequency;

FIG. 12 is a block diagram showing a communication system according to a third embodiment;

FIG. 13 is a diagram showing a transmission efficiency of the power feeding signal in a connection circuit unit;

FIG. 14 is a block diagram showing a connection circuit unit in a communication system according to a fourth embodiment;

FIG. 15 is a diagram showing transmission efficiencies of a power feeding signal and a communication signal in the communication system; and

FIG. 16 is a diagram showing a connection circuit unit according to other embodiments.

### DETAILED DESCRIPTION

### First Embodiment

### Total Structure

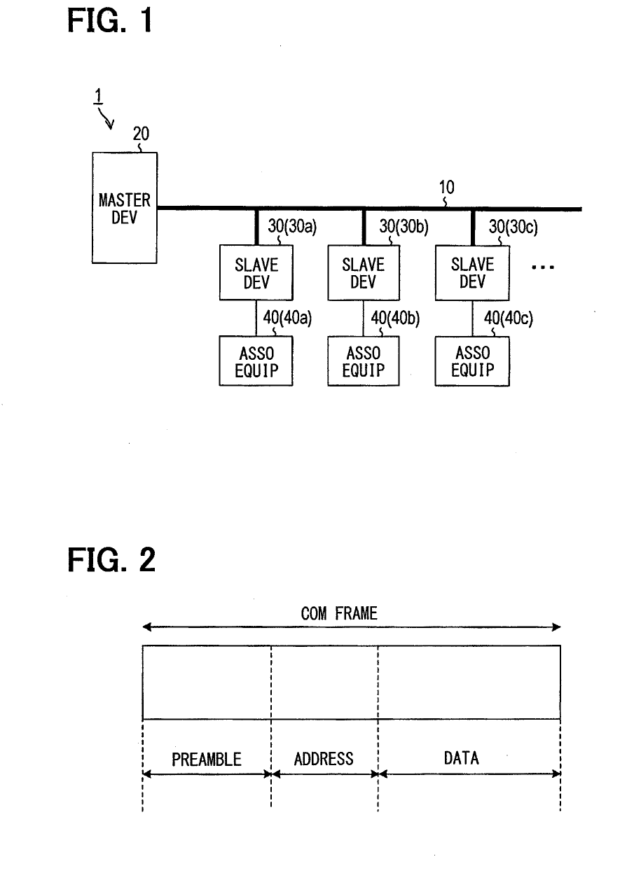

A communication system 1 according to the present embodiment is shown in FIG. 1. The system 1 includes a transmission line 10 in the form of a bus, a master device 20 connected to the transmission line 10, and multiple slave devices 30. Each slave device 30 is energized from the master device 20 via the transmission line 10 so that the slave device 30 functions. Further, each slave device 30 communicates with the master device 20. The slave devices 30 include a first slave device 30a, a second slave device 30b, a third slave device 30c and so on.

Each slave device 30 is connected to a respective equipment (i.e., an associated equipment) 40 for executing a preliminary assigned function. The associated equipments 40 include a first associated equipment 40a corresponding to the first slave device 30a, a second associated equipment 40b corresponding to the second slave device 30b, a third associated equipment 40c corresponding to the third slave device 30c, and so on.

The slave device 30 controls an actuator to function according to an instruction from the master device 20 when the associated equipment 40 is the actuator. Alternatively, when the associated equipment 40 is a sensor, the slave device 30 obtains information from the sensor. Further, each slave device 30 transmits the information, about an operation state of the associated equipment 40 and information obtained from the associated equipment 40, to the master device 20 in response to the instruction from the master device 20.

Thus, in the communication system 1, when the master 20 outputs a communication frame, which specifies one of the slave devices 30 as a communication object, to the transmission line 10, the one of the slave devices 30 executes a response according to a content of the communication frame received from the transmission line 10. Thus, the system 1 executes the communication according to a conventional master-slave type communication protocol.

The communication frame transmitted from the master device 20 to the slave device 30 is referred as a command frame. The communication frame transmitted from the slave device 30 to the master device 20 is referred as a response frame.

As shown in FIG. 2, the command frame includes a preamble portion, an address portion and a data portion.

The preamble portion is disposed at a top of the frame. The preamble portion sets a data column, in which a digit of “1” and a digit of “0” are repeated for a predetermined period. The master device 20 and the slave device 30 generate a system clock for executing a program therein, respectively. With using the system clock, the system 1 generates a clock for a communication control so that the clock is synchronized with a signal (a transmission sign) on the transmission line 10. The preamble portion is used for synchronizing the signal on the transmission line 10 with the clock for the communication control.

The address portion is disposed after the preamble portion. The address portion sets an address of the slave device 30 as a transmission object of the command frame.

The data portion is disposed after the address portion. The data portion includes various instructions (i.e., commands) to the slave device 30 such as a control instruction for changing a state of the associated equipment 40.

The response frame has the same construction as the command frame. Here, in the response frame, the address portion sets an address of the slave device 30 as a transmission source of the response frame. Further, the data portion sets data to be transmitted to the master device 20, the data providing information obtained from the associated equipment 40 by the slave device 30.

<Transmission Line>

The transmission line 10 includes a two-line type twist pair cable. On end of the cable is connected to the master device 20, and another end of the cable is connected via a predetermine impedance.

The transmission line 10 includes multiple connection portions 11, each of which is disposed at a position, at which the slave device 30 for communicating via the transmission line 10 is connected. The connection portions 11 includes a first connection portion 11a corresponding to the first slave device 30a, a second connection portion 11b corresponding to the second slave device 30b, a third connection portion 11c corresponding to the third slave device 30c, and so on. Each connection portion 11 is prepared by deforming the cable to have a shape, which generates effectively a magnetic field having a predetermined direction. Specifically, the connection portion 11 is a ring portion prepared by loosening a twist of the cable, which is twisted to be a twist pair. Here, in space surrounded by the ring portion in the connection portion 11, a magnetic flux penetrating through the space is directed to the same direction.

In the communication and the energization with using the transmission line 10, multiple predetermined frequencies (i.e., specific frequencies) are utilized. Specifically, when the communication frame is transmitted through the transmission line 10, a signal having a selected specific frequency functions as a carrier wave, and a signal modulated by an on-off keying (i.e., OOK) is used.

A specific frequency among one of the predetermined frequencies is assigned to a corresponding slave device 30 so that the device 30 executes the communication and the energization with the master device 20 by the specific frequency.

In the following explanation, the communication system 1 includes the master device 20 and three slave devices 30, which communicate with each other. Further, when individual slave device 30 is distinguished from other slave devices, the first to third slave devices 30a-30c are described. The specific frequencies assigned to the slave devices 30 includes a first specific frequency fa corresponding to the first slave device 30a, a second specific frequency fb corresponding to the second slave device 30b, and a third specific frequency fc corresponding to the third slave device 30c. Here, the first to third frequencies fa-fc has a relationship of “fa<fb<fc.”

<Master Device>

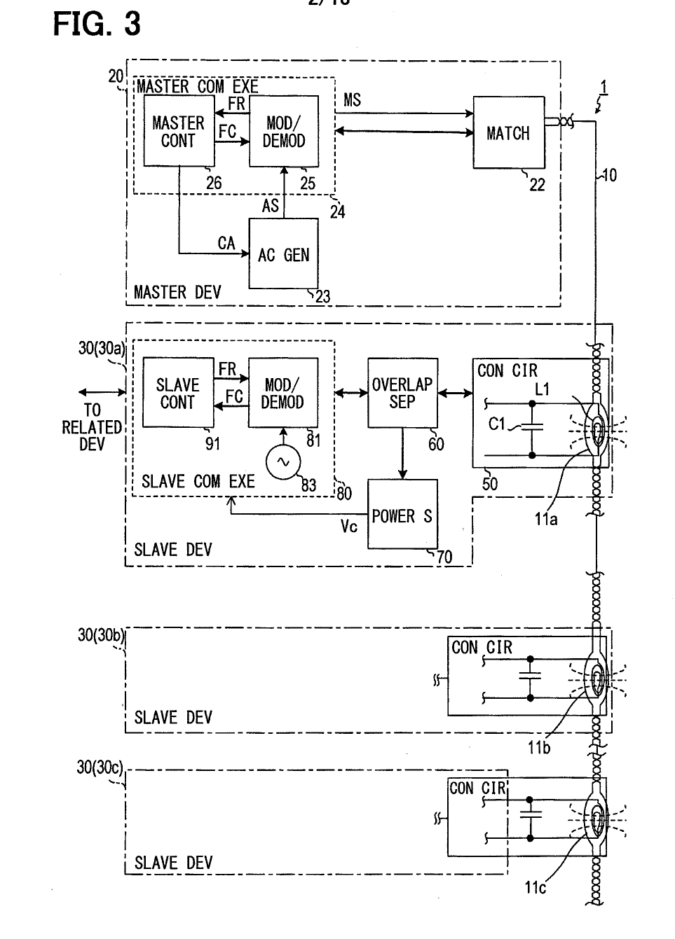

The master device 20 is connected to the transmission line 10, as shown in FIG. 3. The master device 20 includes a matching unit 22 and an alternating current generating unit 23. The matching unit 22 has an input and output impedance, which is changeable with respect to the transmission line 10 according to the instruction of the matching unit setting signal MS. The alternating current generating unit 23 outputs the electric power supply signal AS according to the alternating current setting signal CA.

The master device 20 includes a modulating/demodulating unit 25. The modulating/demodulating unit 25 directly outputs the electric power supply signal AS to the matching unit 22 when the transmission data (i.e., the command frame FC) is not input. When the transmission data is input, the modulating/demodulating unit 25 outputs a signal, which is prepared by modulating with the electric power supply signal AS as the carrier wave according to the transmission data, to the matching unit 22, and the modulating/demodulating unit 25 demodulates the reception data (i.e., a response frame FR) based on the signal input via the matching unit 22.

Further, the master device 20 includes a master control unit 26. The master control unit 26 executes various processes such as a process for generating the matching unit setting signal MS and the alternating current setting signal CA in accordance with the slave device 30 as the communication object, a process for generating the transmission data as the command frame FC and for outputting the transmission data to the modulating/demodulating unit 25, and a process for realizing the content of the reception data as the response frame FR, which is demodulated by the modulating/demodulating unit 25.

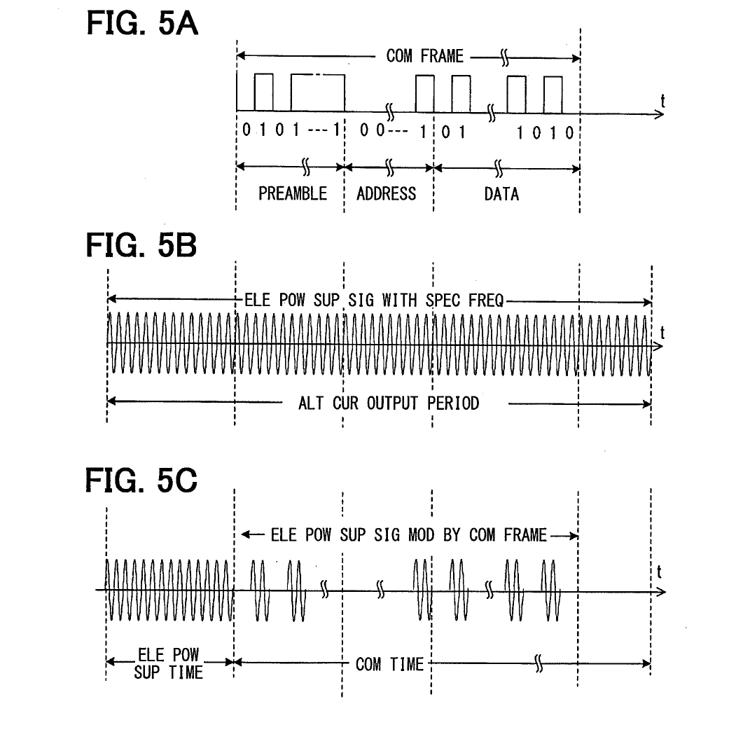

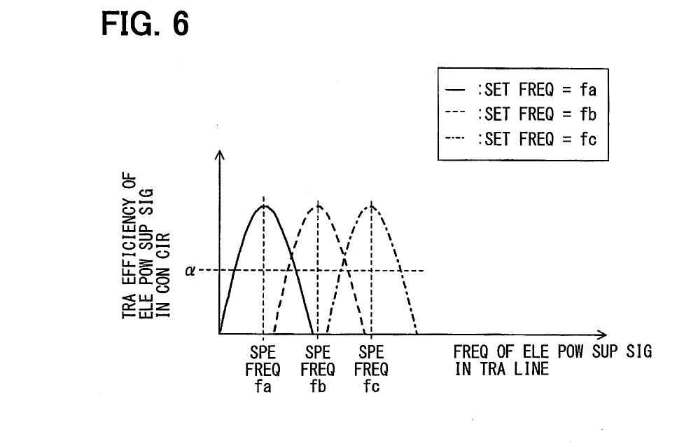

The alternating current generating unit 23 outputs the alternating current signal as the electric power having a frequency, which is selected among multiple specific frequencies, according to the instruction of the alternating current setting signal CA for an instructed period as the alternating current output period. Here, the alternating current output period is set to be a length prepared by adding at least the electric power supply time and the communication time, as shown in FIGS. 5A to 5C. The communication time is defined as necessary time for transmitting the command frame FC. The electric power supply time is defined as necessary time for supplying electricity with using the electric power supply signal AS, and the electricity is consumed by the slave device 30 from time when the slave device 30 starts to receive the command frame FC to time when the slave device 30 completes to transmit the response frame FR. The alternating current output period may be constant among the slave devices 30. Alternatively, the alternating current output period may be different in each slave device 30 as the communication object.

The matching unit 22 changes the input/output impedance according to the matching unit setting signal MS and the electric power supply signal AS so as to reduce the transmission loss of energy in the electric power supply signal AS between the matching unit 22 and the transmission line 10.

The modulating/demodulating unit 25 has a modulating method such as an on-off keying method in such a manner that the modulating/demodulating unit 25 outputs the carrier wave directly when the data indicates “1”, and the modulating/demodulating unit 25 stops outputting the carrier wave when the data indicates “0.”

The master control unit 26 includes at least a communication controller for communicating with the slave device 30, a transmission buffer, in which the data of the command frame FC is written, and a reception buffer, in which the data of the response frame is written, in addition to the micro computer having a CPU and the like. Further, the non-volatile memory for providing the micro computer stores a frequency correspondence table indicative of a relationship between each slave device 30 and a specific frequency.

The master control unit 26 executes at least the master communication process, the transmission data setting process, and the reception data corresponding process. In the master communication process, the master control unit 26 reads out the date from the transmission buffer and writes data to the reception buffer so that the master control unit 26 controls the communication controller for executing the communication with the slave device 30. In the transmission data setting process, the master control unit 26 generates the data to be set in the command frame FC, which is to be transmitted to the slave device 30 in the master communication process. In the reception data corresponding process, the master control unit 26 executes various controls according to the content of data set in the response frame FR, which is received from the slave device 30.

<Master Communication Process>

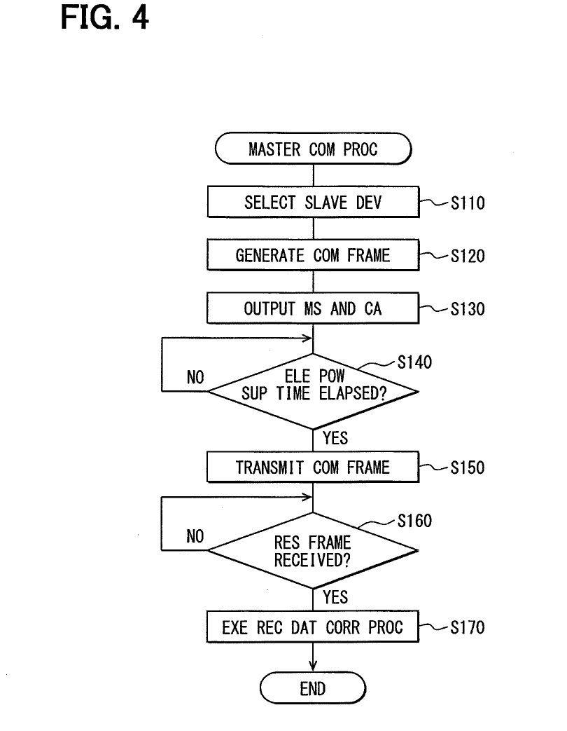

The master communication process executed by the micro computer in the master control unit 26 will be explained with reference to FIG. 4.

When the master device 20 is energized and initialized so that the transmission line 10 is available, the master communication process is executed repeatedly at a predetermined period. When the master communication process is activated, at step S110, one of the slave devices 30 is selected as the communication object in turn according to a predetermined schedule. At step S120, the command frame FC is generated with using the data obtained in the transmission data setting process and the command frame FC is stored in the transmission buffer, the command frame FC being to be transmitted to the selected slave device 30 as the communication object device, as shown in FIG. 5A.

Next, at step S130, the matching unit setting signal MS and the alternating current setting signal CA, which correspond to the specific frequency in relation to the selected slave device 30, are output.

Thus, the alternating current generating unit 23 starts to output the electric power supply signal AS having the specific frequency in relation to the selected slave device 30, as shown in FIG. 5B. Further, the input/output impedance of the matching unit 22 is set to be suitable for the specific frequency. At this time, since the transmission of the command frame FC is not started yet, the modulating/demodulating unit 25 outputs the electric power supply signal AS directly without modulating the electric power supply signal. The non-modulated electric power supply signal AS is output to the transmission line 10 via the matching unit 22, as shown in FIG. 5C.

Next, at step S140, the master device 20 stands by since the alternating current generating unit 23 starts to output the electric power supply signal AS until the electric power supply time has elapsed. When the electric power supply time has elapsed, at step S150, the master device 20 controls the communication controller to start to transmit the transmission data as the command frame FC.

Thus, the modulating/demodulating unit 25 outputs the electric power supply signal AS, which is modulated by the transmission data, and the modulated electric power supply signal AS is output to the transmission line 10 via the matching unit 22, as shown in FIG. 5C.

Then, at step S160, the master device 20 stands by until the response frame FR is received. When the response frame FR is received, at step S170, the master device 20 activates the reception data corresponding process, which is a different process from the master communication process, so that the response frame FR written in the reception buffer is processed. Then, the master communication process is completed.

<Slave Device>

As shown in FIG. 3, the slave device 30 includes a connection circuit unit 50, a slave communication executing unit 80, and a power source 70. The connection circuit unit 50 inputs and outputs the electric power supply signal AS and the communication signal with the transmission line 10 in a non-contact manner. The slave communication executing unit 80 executes the communication with the master device 20 via the connection circuit unit 50 so that the command frame FC is received, and the response frame FR is transmitted. The power source 70 energizes the slave communication executing unit 80 based on the signal obtained via the connection circuit unit 50. The slave device 30 includes an overlapping and separating unit 60. The overlapping and separating unit 60 distributes the signal, which is obtained from the transmission line 10 via the connection circuit unit 50, to the slave communication executing unit 80 and the power source 70. Further, the overlapping and separating unit 60 outputs the signal obtained from the slave communication executing unit 80 to the transmission line 10 via the connection circuit unit 50.

The connection circuit unit 50 and the overlapping and separating unit 60 are provided by a passive component. Thus, the connection circuit unit 50 and the overlapping and separating unit 60 function regardless of the energization from the power source 70. On the other hand, the slave communication executing unit 80 includes an active component. Thus, the slave communication executing unit 80 functions only when the slave communication executing unit 80 is energized from the power source 70.

The connection circuit unit 50 includes a coil L1 and a capacitor C1, which constitutes a resonance circuit. The coil L1 has a spiral shape so that the coil L1 is arranged to be sandwiched between cables of the connection unit 11 of the transmission line 10, in which the twist is loosened.

Specifically, the transmission line 10 and the slave device 30 are arranged so as to execute the non-contact electric power transmission between the cable (i.e., the coil) of the connection unit 11 and the coil L1 with using the magnetic flux as a transmission medium. Thus, the transmission line 10 and the slave device 30 generate electro-magnetic induction. A technique for executing the non-contact electric power transmission with utilizing the electro-magnetic induction is conventional. Thus, the technique is not explained here.

The resonant frequency of the connection circuit unit 50 is referred as a setting frequency. The setting frequency is preliminary set in each slave device 30 so that the setting frequency is selected among multiple specific frequencies that the master device 20 can set each specific frequency.

The power source 70 is a conventional power source circuit including a smoothing circuit and a constant voltage output circuit. The smoothing circuit rectifies and smoothes the signal input from the transmission line 10 via the overlapping and separating unit 60. The constant voltage output circuit converts the output signal from the smoothing circuit to be a constant voltage (referred as a first driving voltage) Vd, and then, outputs the first driving voltage Vd, which is necessary to drive the slave communication executing unit 80.

The capacitor for providing the smoothing circuit is energized by the electric power supply signal AS so that the capacitor functions as a charging circuit for accumulating the electricity.

The output voltage VDD of the power source 70 is kept at the first driving voltage Vd when the accumulated electricity stored in the power source 70 exceeds the consumed electricity at the slave communication executing unit 80. When the accumulated electricity stored in the power source 70 falls below the consumed electricity at the slave communication executing unit 80, the output voltage VDD is made zero volt.

Thus, the power source 70 can continue energizing the slave communication executing unit 80 for a certain period with using the accumulated electricity stored in the power source 70 even when the energization from the electric power supply signal AS is interrupted.

Specifically, when the power source 70 receives the electric power supply signal AS having the set frequency for the electric power supply time, the power source 70 maintains the first driving voltage Vd for at least a slave communication processing time. The slave communication processing time is defined as time, in which the slave communication executing unit 80 executes a series of processes from a process that the slave communication executing unit 80 receives the command frame FC to a process that the slave communication executing unit 80 transmits the response frame FR in response to the received command frame.

Here, the relationship between the property of the connection circuit unit 50 and the first driving voltage Vd will be explained with reference to FIG. 6.

The property of the connection circuit unit 50, i.e., the relationship between the frequency of the electric power supply signal AS and the transmission efficiency of the electric power supply signal AS at the connection circuit unit 50, is shown in FIG. 6. As shown in FIG. 6, the transmission efficiency of the electric power supply signal in the connection circuit unit 50 has a peak at the setting frequency (i.e., the set specific frequency). As the frequency is separated from the set specific frequency, the transmission efficiency is reduced. Specifically, when the electric power supply signal AS having the frequency different from the set specific frequency is output to the transmission line 10, the energization from the transmission line 10 to the slave device 30 is not gone completely, but the energization with a low efficiency is maintained.

Here, the slave device 30 is constituted such that the power source 70 can maintain the first driving voltage Vd when the transmission efficiency of the connection circuit unit 50 is equal to or larger than α.

In this case, the constant parameter and interval of the specific frequencies of the connection circuit unit 50 are set such that the transmission efficiency γ has a relationship of γ<α. The transmission efficiency γ is defined when the electric power supply signal AS having the frequency different from the set specific frequency is output to the transmission line 10.

Thus, only when the electric power supply signal AS having the set specific frequency is output to the transmission line 10, the power source 70 can maintain the first driving voltage Vd, so that the slave communication executing unit 80 functions.

Here, since the slave device 30 is provided by a passive component, even when the electric power supply by the electric power supply signal AS is interrupted, the set specific frequency is always maintained.

The slave communication executing unit 80 includes an oscillator 83, a modulating/demodulating unit 81 and a slave control unit 91. The oscillator 83 generates the alternating current signal having a predetermined frequency. The generated alternating current signal is supplied to the modulating/demodulating unit 81, so that the generated alternating current signal is used as the carrier wave for modulation and demodulation. Here, the frequency of the carrier wave coincides with the set specific frequency. Specifically, the frequency of the carrier wave for modulation and demodulation is set to be equal to the set specific frequency of the electric power supply signal AS for electric power supply.

The modulating/demodulating unit 81 includes a modulating unit and a demodulating unit. The demodulating unit demodulates the communication signal supplied from the overlapping and separating unit 60 so that the demodulating unit generates the reception data (i.e., the command frame FC), and supplies the command frame FC to the slave control unit 91. The modulating unit modulates the signal having the set specific frequency (by the on-off keying method) based on the transmission data (i.e., the response frame FR) supplied from the slave control unit 91 so that the modulating unit generates the communication signal, and supplies the generated communication signal to the overlapping and separating unit 60.

The slave control unit 91 includes a micro computer having a CPU mainly, a communication controller, a reception buffer and a transmission buffer, similar to the master control unit 26.

The slave control unit 91 executes various processes such as a process for transmitting the response frame FR in response to the received command frame FC, and a process for realizing the content of the command frame FC.

Here, a state of the slave device 30, which is energized since the power source 70 maintains the first driving voltage Vd, is defined as an active state. A state of the slave device 30, which can not be energized under a condition that the power source 70 maintains the first driving voltage Vd, is defined as a stop state.

<Function>

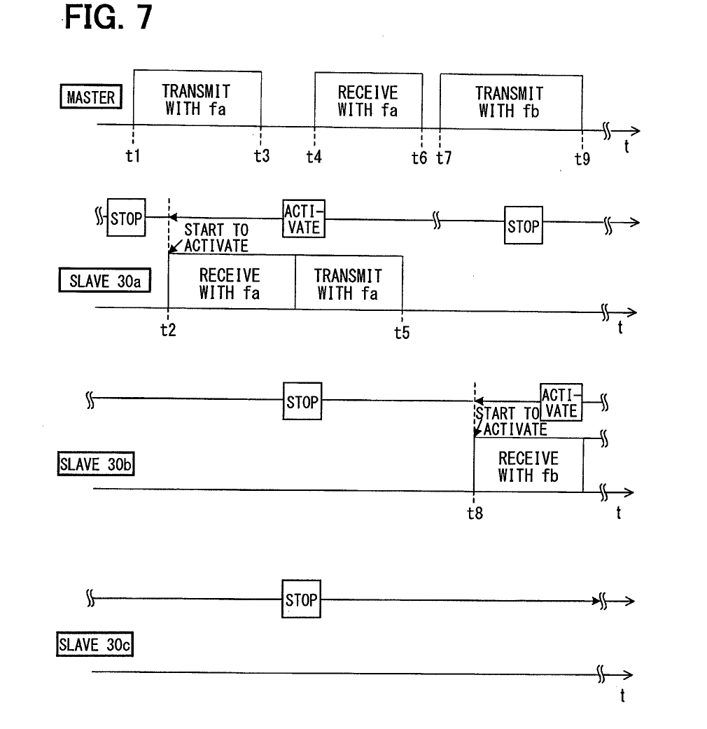

The operation of the communication system having the above constitution will be explained with reference to FIG. 7. The master device 20 outputs the electric power supply signal AS having the specific frequency of fa to the transmission line 10 at time t1. Then, the master device 20 transmits the command frame FC (which is a signal prepared by modulating with using the electric power supply signal AS having the specific frequency of fa as the carrier wave) to the transmission line 10. The command frame FC sets the address of the first slave device 30a.

Here, the first slave device 30a is in the active state at time t2 since the first slave device 30a has the set specific frequency equal to the specific frequency of fa. Then, the first slave device 30a executes a series of the slave communication process from time t2 to time t5. The master device 20 demodulates the response frame FR generated in the slave device 30a based on the signal received from the transmission line 10, and executes the process according to the content of the response frame FR. Then, the master device 20 completes the series of the process from time t4 to time t6.

During the period between time t1 and time t6, the second slave device 30b having the set frequency different from the specific frequency fa and the third slave device 30c having the set frequency different from the specific frequency fa are in the stop state.

Further, after time t6, the electric power supply signal AS having the specific frequency fa is not output to the transmission line 10, and therefore, the energization to the first slave device 30a via the transmission line 10 is stopped. Thus, the power source 70 of the first slave device 30a can not maintain the first driving voltage Vd, so that the first slave device 30a is in the stop state.

Next, the master device 20 outputs the electric power supply signal AS having the specific frequency of fb to the transmission line 10 at time t7. Then, the master device 20 transmits the command frame FC (which is a signal prepared by modulating with using the electric power supply signal AS having the specific frequency of fb as the carrier wave) to the transmission line 10 from time t7 to time t9. The command frame FC sets the address of the second slave device 30b.

Thus, the second slave device 30b becomes in the active state at time t8 since the second slave device 30b has the set specific frequency equal to the specific frequency of fb. Then, the second slave device 30b executes a series of the slave communication process.

Thus, the operation similar to the operation from time t1 to time t6 is performed under a condition that the specific frequency of fa is replaced to fb, and the first slave device 30a is replaced to the second slave device 30b. Specifically, only the second slave device 30b as the communication object of the master device 20 is in the active state, and the other slave devices 30a, 30c are in the stop state.

Thus, in the communication system 1, the master device 20 changes the frequency of the electric power supply signal AS so that each slave device 30a-30c is controlled to switch between the active state and the stop state.

<Effects of First Embodiment>

In the communication system 1, when the master device 20 communicates with the slave device 30, the master device 20 starts to execute the communication after the master device 20 outputs the electric power supply signal AS having the frequency equal to the set frequency of the slave device 30 as the communication object for the electric power supply time.

Accordingly, in the communication system 1, the electric power supply to the other slave devices 30, which are not the communication object, and have the set frequencies different from the specific frequency of the communication object slave device 30, is restricted. Accordingly, the consumption electric power of a whole of the communication system 1 is limited.

Further, in the communication system 1, since the slave device 30 is electrically coupled with the transmission line 10 in a non-contact manner, the transmission line 10 and the slave device 30 are arranged without contacting with each other. Thus, the water-proof of the slave device 30 is improved. Further, the degree of freedom regarding the arrangement of the slaved device 30 with respect to the transmission line 10 is improved.

Further, in the communication system 1, the electric power supply signal AS is used as the carrier wave, and the connection circuit unit 50 functions as both of the connection circuit for energization and the connection circuit for communication. Thus, the construction of the master device 20 and the slave device 30 is simplified. As a result, the dimensions of each device and a whole of the communication system are minimized.

The alternating current generating unit 23 corresponds to an electric power supply unit. The master communication executing unit 24 having the modulating/demodulating unit 25 and the master control unit 26 corresponds to the master communication device. Step S130 in the master communication process corresponds to the electric power supply frequency setting unit.

Further, the connection circuit unit 50 corresponds to the electric power supply signal input and output device and the communication signal input and output device. The slave communication executing unit 80 corresponds to the slave communication device. The power supply 70 corresponds to the power supply device. The first driving voltage Vd corresponds to the first threshold value.

<Modifications>

In the communication system according to the first embodiment, one specific frequency is assigned to one slave device 30. For example, the slave devices 30 are classified into one or multiple slave device groups. One specific frequency may be assigned to one slave device group. Thus, in the communication system 1, a slave device group to be activated is switched according to a change of the frequency in the electric power supply signal output from the master device 20.

Specifically, in the frequency corresponding table in the master device 20, one slave device 30 corresponds to one specific frequency according to the first embodiment. Alternatively, in the frequency corresponding table in the master device 20, one or multiple slave devices 30 correspond to one specific frequency. Further, in each slave device 30, the set frequency of the connection circuit unit 50 and the frequency of the alternating current signal as the carrier wave output from the oscillator 83 are set to be the specific frequency in association with the frequency table.

Thus, for example, multiple slave devices 30 having high communication repetition of communicating with the master device 20 are sorted to one group. In this case, while the slave devices 30 are communicating with the master device 20, energization to other slave devices 30 having low communication repetition with the master device 20 is limited. Thus, the degree of freedom in the design of the communication system 1 is improved.

Further, when the master device 20 executes the communication with the slave devices 30 in the same group in turn serially, it is not necessary to change the frequency of the electric power supply signal AS used for the electric power supply to each slave device 30 in the same group. Thus, since all of the slave devices 30 in the same group are in the active state when the second or more time communication with the slave devices in the same group is performed, the waiting time for activating the slave devices 30 is reduced, so that the necessary time for communication is reduced.

### Second Embodiment

Next, a second embodiment will be explained as follows.

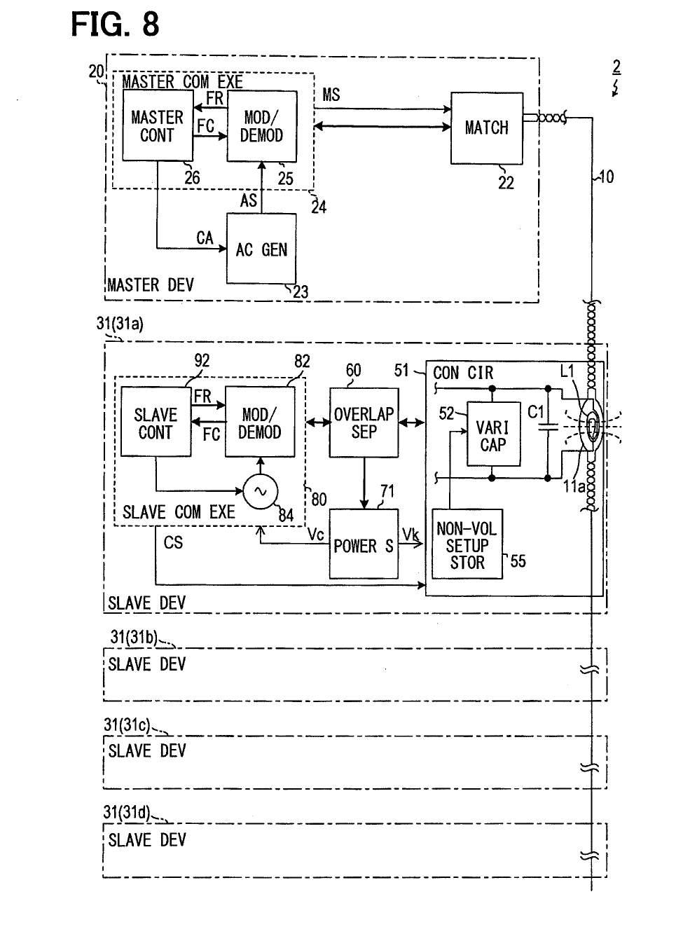

In the communication system 2 according to the second embodiment in FIG. 8, the set frequency of the slave device 31 is changeable according to an instruction from the master device 20. Thus, in the communication system 2, the contents of processes executed by the slave device 31 and the master device 20 and a part of the construction of the slave device 31 are different from the first embodiment. The differences between the first and second embodiments will be mainly explained as follows.

In the communication system 2, predetermined multiple specific frequencies are used for the communication and the energization with using the transmission line 10. In the second embodiment, four specific frequencies are preliminary prepared. The four specific frequencies include a first to fourth specific frequencies f1-f4, which are arranged in ascending order. Thus, the first frequency f1 is the lowest frequency, and the fourth frequency f4 is the highest frequency.

<Master Device>

The master device 20 transmits the instruction as the command frame FC for instructing the setting and changing of the set frequency to the slave device 31.

In the reception data corresponding process that is activated when the master device 20 receives the response frame FR in response to the command frame FC, the master device 20 executes a step for re-writing the content of the frequency corresponding table, which indicates a relationship between the slave device 31 and the specific frequency, according to the content of the instruction.

<Slave Device>

Comparing with the first embodiment, in the slave device 31, the construction of the connection circuit unit 51 is different, the slave control unit 92 executes a process for changing the set frequency according to an instruction when the slave control unit 92 receives the instruction as the command frame FC for instructing the setting and changing of the set frequency, the construction of the oscillator 84 is different, and the power source 71 supplies the electricity to the connection circuit unit 51.

<Connection Circuit Unit>

As shown in FIG. 8, the connection circuit unit 51 further includes a variable capacitance unit 52 and a non-volatile setup storing unit 55 in addition to the same constitution as the connection circuit unit 50 according to the first embodiment. The variable capacitance unit 52 is connected in parallel to the capacitor C1, and has a variable capacitance in a stepwise manner. The non-volatile setup storing unit 55 switches the setup of the variable capacitance unit 52 according to the frequency selection signal CS obtained from the communication executing unit 80. Further, the non-volatile setup storing unit 55 maintains a switched state.

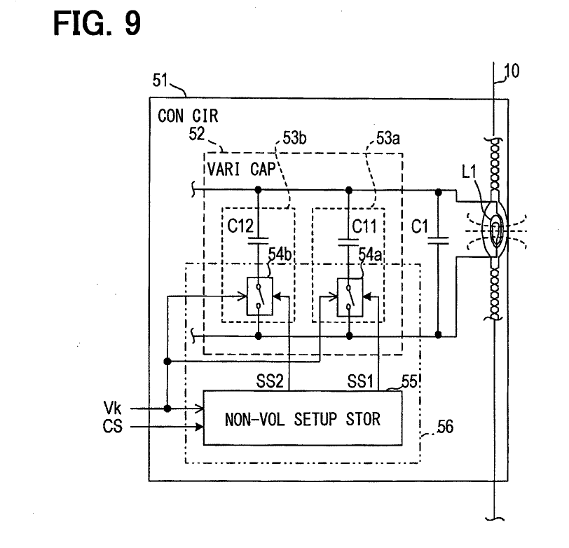

As shown in FIG. 9, the variable capacitance unit 52 includes a first capacitor unit 53a and a second capacitor unit 53b, which are connected in parallel to each other. In the first capacitor unit 53a, a capacitor C11 and a switch 54a are connected in series. In the second capacitor unit 53b, a capacitor C12 and a switch 54b are connected in series. The switches 54a, 54b include a MOS transistor and the like. The switches 54a, 54b maintain a switching state of one of an opening state and a closed state according to switching signals SS1, SS2, which are supplied from the non-volatile setup storing unit 55.

The non-volatile setup storing unit 55 outputs the switching signals SS1, SS2 according to the frequency selection signal CS, so that the non-volatile setup storing unit 55 sets one of four states, which are obtained by a combination of the opening state and the closed state in the switches SS1, SS2.

The non-volatile setup storing unit 55 is driven by an output of the second constant voltage output circuit. While the output voltage of the second constant voltage output circuit is maintained to be the second driving voltage Vk, the non-volatile setup storing unit 55 maintains and outputs the setting content (i.e., signal levels of the switching signals SS1, SS2). Specifically, the non-volatile setup storing unit 55 may include a S-RAM (static random access memory) having quite low electric power consumption in a set content storing state, a flash memory for storing a set content even if the flash memory is not energized from a power source, or the like.

Thus, four kinds of capacitances of the variable capacitance unit 52 can be selected by switching the switches 54a, 54b. The capacitances of the capacitors C1, C11, C12 are preliminary determines such that each kind of capacitances of the variable capacitance unit 52 as a resonant frequency (i.e., specific frequency) corresponds to the first specific frequency f1, the second specific frequency f2, the third specific frequency f3 and the fourth specific frequency f4, respectively.

The non-volatile setup storing unit 55 and the switches 54a, 54b provide a setting condition storing unit 56. The setting condition storing unit 56 is driven by the second driving voltage Vk, which is supplied to the connection circuit unit 51.

<Power Source>

The power source 71 further includes a second constant voltage output circuit in addition to the construction of the power source 70 according to the first embodiment. The second constant voltage output circuit converts the output of the smoothing circuit to be a certain constant voltage (i.e., a second driving voltage) Vk necessary for driving the setting condition storing unit 56, and outputs the second driving voltage Vk. Here, the second driving voltage Vk is lower than the first driving voltage Vd, i.e., an equation of “Vk<Vd” is satisfied.

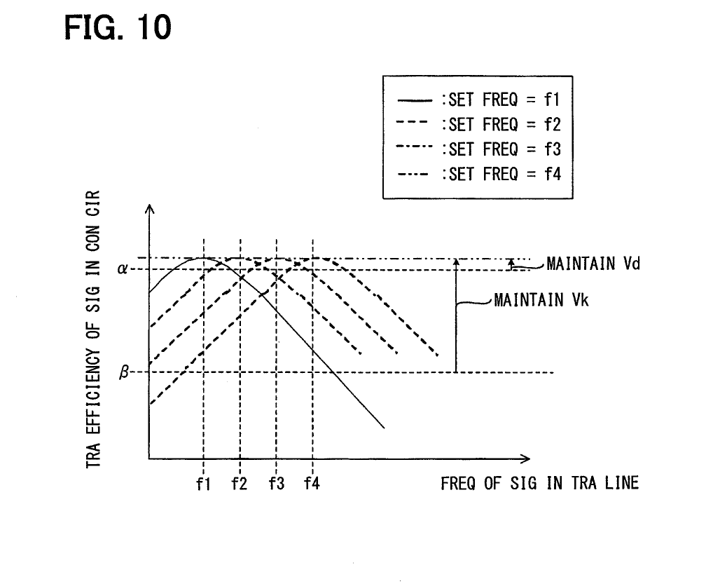

The relationship among the property of the connection circuit unit 51, the first driving voltage Vd and the second driving voltage Vk will be explained with reference to FIG. 10.

The property of the connection circuit unit 51, i.e., the relationship between the frequency of the electric power supply signal AS and the transmission efficiency of the electric power supply signal AS at the connection circuit unit 51, is shown in FIG. 10. As shown in FIG. 10, the transmission efficiency of the electric power supply signal AS in the connection circuit unit 51 has a peak at the setting frequency (i.e., the set specific frequency). As the frequency is separated from the set specific frequency, the transmission efficiency is reduced. Specifically, when the electric power supply signal AS having the frequency different from the set specific frequency is output to the transmission line 10, the energization from the transmission line 10 to the slave device 30 is not gone completely, but the energization with a low efficiency is maintained.

Here, the slave device 30 is constituted such that the power source 71 can maintain the first driving voltage Vd when the transmission efficiency of the connection circuit unit 51 is equal to or larger than α, and the power source 71 can maintain the second driving voltage Vk when the transmission efficiency of the connection circuit unit 51 is equal to or larger than β.

In this case, the constant parameter and an interval of the specific frequencies of the connection circuit unit 51 are set such that the transmission efficiency η has a relationship of β<η<α. The transmission efficiency η is defined when the electric power supply signal AS having the frequency different from the set specific frequency is output to the transmission line 10.

Thus, only when the electric power supply signal AS having the set specific frequency is output to the transmission line 10, the power source 71 can maintain the first driving voltage Vd, so that the slave communication executing unit 80 functions. Further, even when the electric power supply signal AS having the frequency other than the set specific frequency is output to the transmission line 10, the power source 71 can maintain the second driving voltage Vk, so that the setting condition storing unit 56 functions.

When the transmission efficiency of the connection circuit unit 51 is equal to or larger than a predetermined value, i.e., when the transmission efficiency of the connection circuit unit 51 has a certain value, at which the second driving voltage Vk can be maintained, the set frequency stored at the present time is maintained (i.e., stored). This feature is defined as “non-volatile.”

<Communication Executing Unit>

As shown in FIG. 8, the slave communication executing unit 80 includes an oscillator 84, a modulating/demodulating unit 82 and a slave control unit 92.

Compared with the oscillator 83 according to the first embodiment, the oscillator 84 can change the frequency of the signal as the carrier wave according to the frequency setting signal FS output from the slave control unit 92 when the modulation and the demodulation are performed. The oscillator 84 includes, for example, a conventional VCO (voltage controller oscillator). The frequency of the signal as the carrier wave is set to be one of first to fourth specific frequencies f1 to f4 according to the frequency setting signal FS.

The slave control unit 92 executes various processes such as a slave communication process similar to the first embodiment and a process for outputting the frequency selection signal CS in accordance with the instruction content when the content of the command frame FC includes an instruction for changing the set frequency.

After the frequency selection signal CS is output, the resonance frequency of the connection circuit unit 51 is set to be the specific frequency defined in the command frame FC. After the frequency setting signal FS is output, the frequency of the alternating current signal to be the carrier wave, which is used for the modulation and the demodulation at the modulating/demodulating unit 82, is switched to the specific frequency defined in the command frame FC.

<Operation>

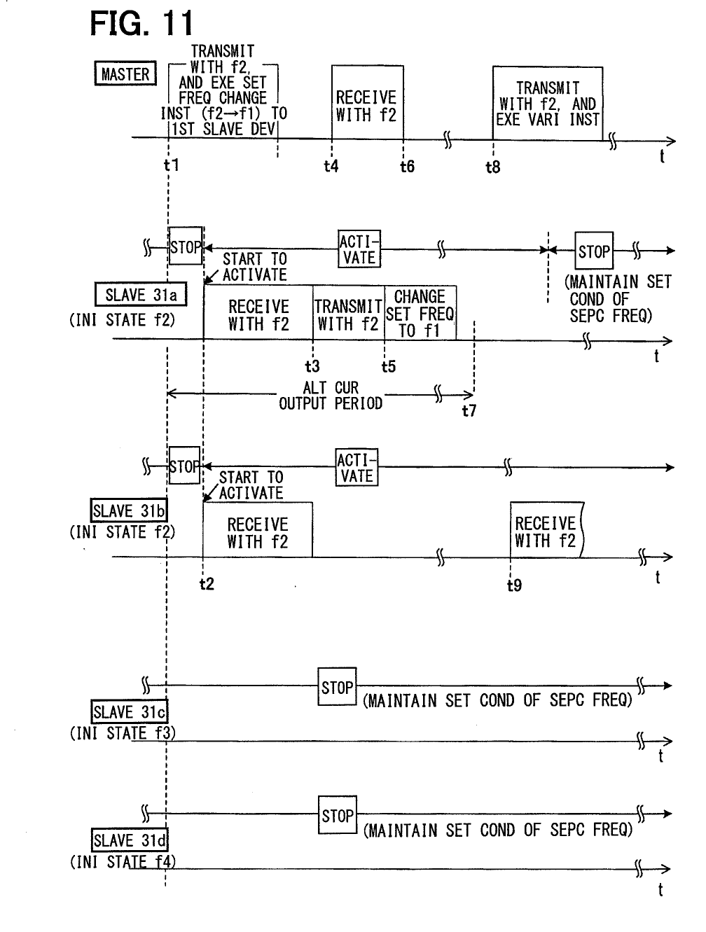

The operation of the communication system 2 having the above constitution will be explained with reference to FIG. 11. In the following explanation, in the communication system 2, the master device 20 communicates with four slave devices 31a-31d. The first slave device 31a and the second slave device 31b have an initial value of the specific frequency, which is set to be the second specific frequency f2. The third slave device 31c has an initial value of the specific frequency, which is set to be the third specific frequency f3. The fourth slave device 31d has an initial value of the specific frequency, which is set to be the fourth specific frequency f4. Alternatively, the number of slave devices 31 and the relationship between the slave device 31 and the specific frequency are not limited to the above feature.

First, the master device 20 outputs the electric power supply signal AS having the second specific frequency f2 to the transmission line 10 at time t1. Then, the master device 20 transmits the command frame FC (which is a signal prepared by modulating with using the electric power supply signal AS having the second specific frequency of f2 as the carrier wave) to the transmission line 10. The command frame FC sets the address of the first slave device 31a. Here, the command frame FC provides an instruction for changing the set frequency from the second specific frequency f2 to the first specific frequency f1.

Here, the first and second slave devices 31a, 31b are in the active state at time t2 since the first and second slave devices 31a, 31b have the set specific frequency equal to the second specific frequency of f2. Then, the first slave device 31a, which is designated to an address (i.e., an object) of the command frame FC under a condition that the first and second slave devices 31a, 31b are in the active state, transmits the response frame FR at time t3. Then, the first slave device 31a executes a series of the process at time t5 according to the instruction content of the command frame FC. Here, the first slave device 31a executes a process for changing the set frequency to the first specific frequency f1 (i.e., a process for outputting the frequency selection signal CS and the frequency setting signal FS) at time t5. Further, the first slave device 31a stores the setting condition of the first specific frequency f1 as the electric power supply frequency after changing in the non-volatile setup storing unit 55, which includes a SRAM. Then, the first slave device 31a completes the series of the process.

The master device 20 demodulates the response frame FR generated in the first slave device 31a based on the signal received from the transmission line 10 from time t4 to time t6. Thus, the master device 20 executes a process for rewriting the content in the frequency corresponding table to assign the first specific frequency f1 to the first slave device 31a.

During the period between time t1 and time t6, the third and fourth slave devices 31c, 31d having the set frequency different from the second specific frequency f2 are in the stop state.

Next, the master device 20 transmits the command frame FC (which is a signal prepared by modulating with using the electric power supply signal AS having the second specific frequency of f2 as the carrier wave) to the transmission line 10 at time 8. The command frame FC sets the address of the second slave device 31b so as to communicate with the second slave device 31b.

Thus, the second slave device 31b becomes in the active state at time t9 since the second slave device 31b has the set specific frequency equal to the second specific frequency of f2. Then, the second slave device 31b starts to execute a series of the slave communication process.

The third and fourth slave devices 31c, 31d having the set frequency different from the second specific frequency f2 are continuously in the stop state.

The first slave device 31a becomes in the stop state since the electric power supply signal AS having the first specific frequency f1 is not transmitted on the transmission line 10 after time t7.

Thus, in the communication system 2 according to the second embodiment, the slave device 31 changes the set frequency according to the instruction of the master device 20.

Thus, the grouping condition of the slave devices 31 for grouping an activating group and a stopping group is appropriately changed in accordance with the operation condition of the communication system 2.

As a result, in the communication system 2, the active state and the stop state of the slaved devices 31 in each group are controlled sensitively according to the operation condition of the communication system 2. Thus, the electric power consumption of a whole of the communication system 2 is suppressed.

Further, even when the set frequency is different, the constitution of each slave device 31 is designed to be the same. The manufacturing process of the slave devices 31 is simplified.

In the present embodiment, the connection circuit unit 51 corresponds to the electric power supply signal input/output device and the communication signal input/output device. The power source 71 corresponds to the power source device. The variable capacitance unit 52 corresponds to the setup switching and storing device. The setup storing unit 56 corresponds to the setup frequency changing device. The second driving voltage Vk corresponds to the second threshold value.

### Third Embodiment

The communication system 3 according to the third embodiment has almost similar construction to the first embodiment. In the communication system 1 according to the first embodiment, the electric power supply signal AS is used as the carrier wave. In the communication system 3 according to the third embodiment, a signal other than the electric power supply signal AS is used as the carrier wave.

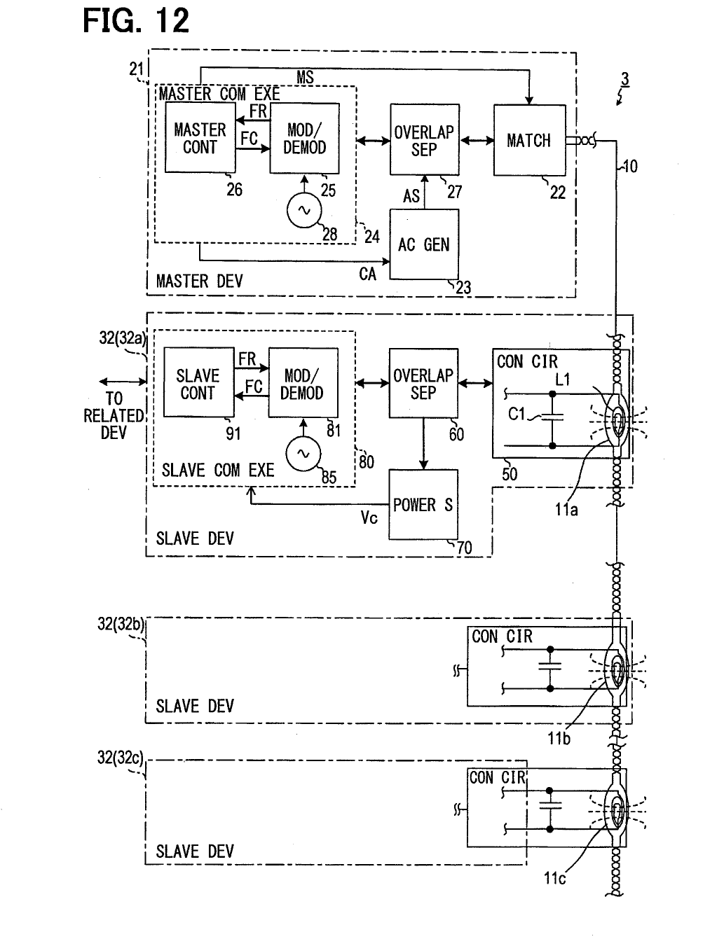

Specifically, as shown in FIG. 12, in the communication system 3, the master device 21 further includes an oscillator 28 and an overlapping and separating unit 27.

The oscillator 28 generates one or more types of signals having predetermined frequencies, and supplies the signals as a carrier wave to the modulating/demodulating unit 25. The signals from the oscillator 28 are different from the electric power supply signal AS.

The overlapping and separating unit 27 outputs a signal input from the matching unit 22 to the master communication executing unit 24 (i.e., to the modulating/demodulating unit 25). When the transmission data as the command frame FC is input into the overlapping and separating unit 27 from the master communication executing unit 24 (i.e., to the modulating/demodulating unit 25), the overlapping and separating unit 27 superimposes communication signal, which is prepared by modulating the carrier wave supplied from the oscillator 28 according to the transmission data, upon the electric power supply signal AS output from the alternating current generating unit 23, so that the overlapping and separating unit 27 outputs the superimposed signal to the matching unit 22. When no transmission data is available, the overlapping and separating unit 27 outputs only the electric power supply signal AS to the matching unit 22.

In the slave device 32, an oscillator 85 generates a signal similar to the carrier wave set in the master device 21 (i.e., the oscillator 28), and then, supplies the signal to the modulating/demodulating unit 81.

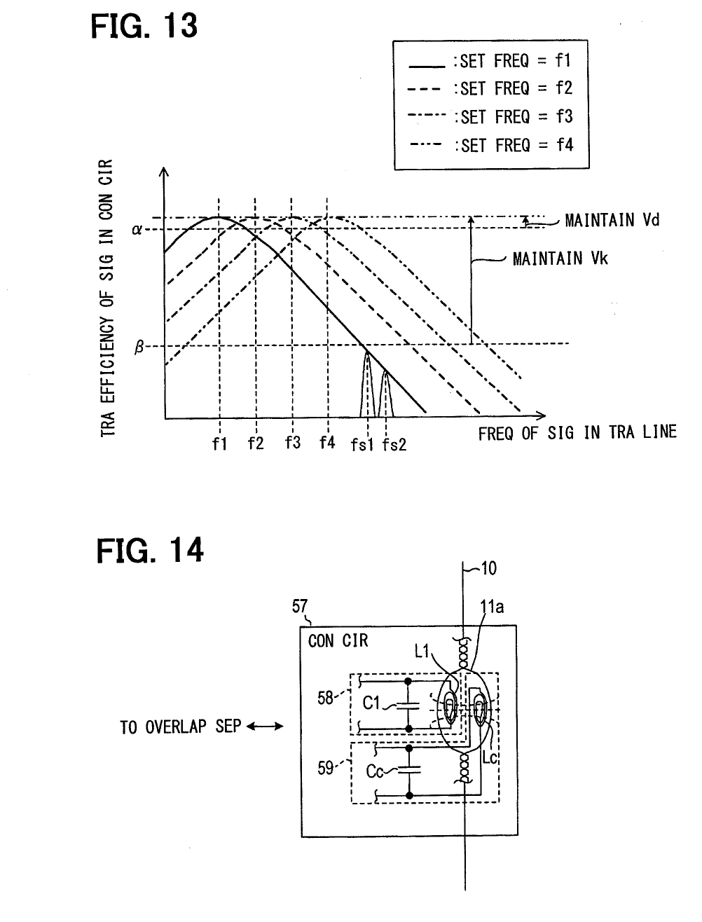

Here, the frequency available in the electric power supply signal AS is selected one of four specific frequencies f1 to f4, as shown in FIG. 13. Further, the frequency of the communication signal (i.e., the frequency of the carrier wave) is set to be a frequency far from the first to fourth specific frequencies f1 to f4. For example, the frequency of the communication signal may be selected one of the first communication frequency fs1 and the second communication frequency fs2, which are higher than the fourth specific frequency f4, as shown in FIG. 13.

The frequency of the communication signal is set commonly in all of the slave devices 32. As the frequency of the communication signal separates from the first to fourth specific frequencies f1 to f4, the transmission efficiency of the communication signal when the communication signal is received by each slave device 32 is reduced.

Thus, the reception circuit at each slave device 32 for receiving the signal on the transmission line 10 may include an amplifier for amplifying the communication signal having the frequency far from the specific frequency. Here, the frequency range of the communication signal may be determined such that the communication quality preliminary determined in the communication system 3 is secured with using the communication signal amplified by the amplifier.

Thus, in the communication system 3 according to the present embodiment, since the construction (i.e., the transmission circuit in the master device 21 and the reception circuit in the slave device 32) used for the transmission and the reception of the communication signal is communalized. Thus, the manufacturing method of each device is simplified.

Further, the carrier wave has two different frequencies such as the first communication frequency fs1 and the second communication frequency fs2. Thus, the modulation method may be a FSK (frequency shift keying) method instead of the OOK (on-off keying) method.

### Fourth Embodiment

In the above embodiment, the connection circuit unit 50 in the slave device 30 provides both of a circuit (i.e., an electric power supply connection circuit) and a circuit (i.e., a communication connection circuit). The electric power supply connection circuit inputs and outputs the electric power supply signal AS with the transmission line 10 in a non-contact manner. The communication connection circuit inputs and outputs the communication signal. In the fourth embodiment, as shown in FIG. 14, the connection circuit unit 57 may include an electric power supply connection circuit 58 and a communication connection circuit 59. The electric power supply connection circuit 58 corresponds to the connection circuit unit 50.

The communication connection circuit 59 includes a capacitor Cc and a coil Lc, similar to the electric power supply connection circuit 58. The non-contact communication of the communication signal between the coil Lc and the connection portion 11a of the cable via a magnetic flux is performed. The resonant frequency between the capacitor Cc and the coil Lc may be set to a certain frequency fs, which is disposed between the first communication frequency fs1 and the second communication frequency fs2.

In the communication system having the connection circuit unit 57 according to the present embodiment, the transmission efficiency of the signal having the first communication frequency fs1 or the second communication frequency fs2 at the communication connection circuit 59 has a peak in the transmission property at the communication connection circuit 59, as shown in FIG. 15. Thus, compared with the third embodiment, it is not necessary to equip the amplifier for amplifying the signal having the first communication frequency fs1 or the second communication frequency fs2. Thus, the electric power consumption at each slave device 30 is restricted. Further, the electric power consumption in a whole of the communication system is restricted.

Here, the electric power supply connection circuit 58 corresponds to the electric power supply signal input/output device. The communication connection circuit 59 corresponds to the communication signal input/output device.

### Other Embodiments

For example, in the communication system 2 according to the second embodiment, even when the electric power supply signal AS on the transmission line 10 is set to one of the first to fourth specific frequencies f1 to f4, the property of the connection circuit unit 51 and the interval between the specific frequencies are determined so as to maintain the second driving voltage Vk by the power source 71 of each slave device 31.

Alternatively, in a case where the property of the connection circuit unit 51 and the interval between the specific frequencies are not determined to maintain the second driving voltage Vk, in the communication system, the master device may intermittently supply the electric power supply signal AS to each slave device so as to maintain the second driving voltage Vk.

In the third embodiment, the modulation method is the FSK. Alternatively, the modulation method may be a phase modulation method such as a QPSK (quadrature phase shift keying) method or a phase amplitude modulation method such as a 16 QAM (16 quadrature amplitude modulation) method. In these cases, the communication speed is improved.

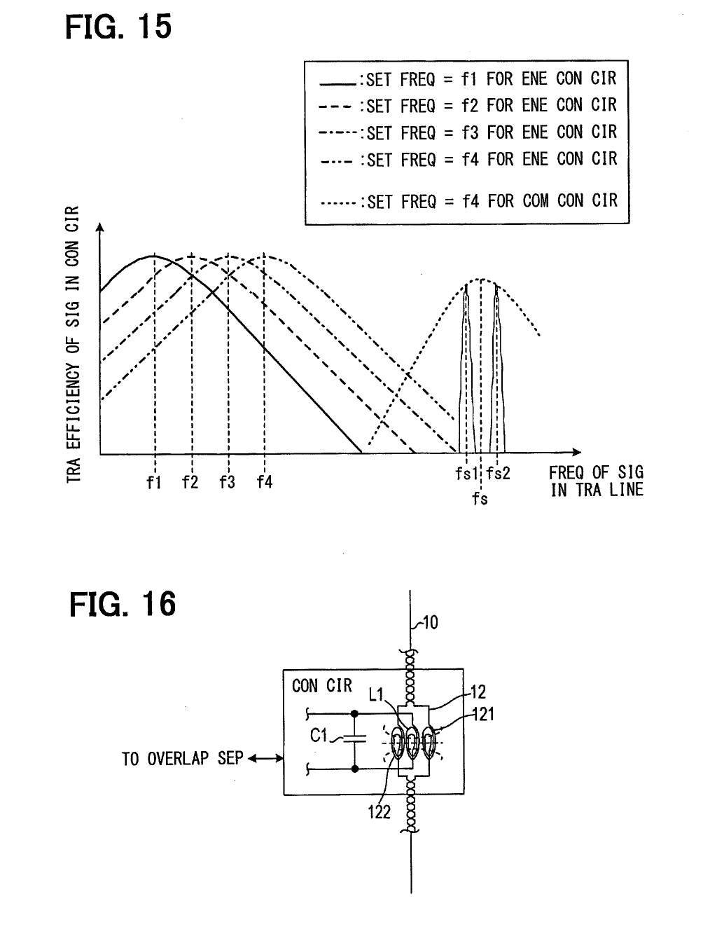

In the above embodiments, the connection circuit unit 50 retrieves the electric power supply signal AS from the transmission line 10 without contacting the transmission line 10 by using electromagnetic induction. Alternatively, the connection circuit unit 50 retrieves the electric power supply signal AS from the transmission line 10 without contacting the transmission line 10 by using electromagnetic resonance. Further, the shape of the connection portion 11 and the shape of the coil in the connection circuit unit 50 are not limited to the above embodiments as long as the connection portion 11 and the coil in the connection circuit unit 50 mutually generate the electromagnetic induction. For example, as shown in FIG. 16, a portion of the connection portion 12 prepared by loosening a twist of the cable may have a spiral pattern.

In the second embodiment, when the transmission efficiency of the connection circuit unit 51 is equal to or larger than a predetermined value, the current set frequency is stored (i.e., maintained), and this feature is referred as “non-volatile.” Here, when the transmission efficiency is zero, i.e., when no electric power supply signal is supplied, the situation corresponds to the first embodiment. Specifically, in the first embodiment, even when the transmission efficiency of the connection circuit unit 50 is zero, the set frequency is maintained, so that this feature is defined that the connection circuit unit 50 is non-volatile.

In the second embodiment, a process for setting and changing the set frequency of the slave device 31 is executed by an instruction (i.e., the command frame FC) as a trigger from the master device 20. Alternatively, the process for setting and changing the set frequency may be executed by a request from a associated equipment 40 as a trigger.

In the second embodiment, only two types of the specific frequencies, i.e., the first and second specific frequencies, are used. Thus, the frequency of the electric power supply signal may be set to one of two types of the specific frequencies.

Here, the slave device 31 stores the set frequency of the slave device 31 in the non-volatile setup storing unit 55, similar to the second embodiment. Further, the first and second specific frequencies are preliminary stored. Further, the slave device 31 can change the setup of the variable capacitance unit 52 according to the control signal from the associated equipment 40 connected to the slave device 31, and the setting condition is stored in the non-volatile setup storing unit 55.

The master device 20 transmits the command frame FC for requiring the response from the slave device 31 with using the electric power supply signal AW with the first specific frequency f1 in turn with respect to all of the slave devices 31 periodically. Then, the master device 20 transmits the command frame FC for requiring the response from the slave device 31 with using the electric power supply signal AW with the second specific frequency f2. The master device 20 updates the frequency corresponding table according to the response from all of the slave devices 31. Here, the process for updating the frequency table periodically is referred as a frequency confirmation operation.

In the above communication system, for example, the slave device 31a having the set frequency equal to the first specific frequency f1 is in the stop state, and the slave device 31a is activated again when the variable capacitance unit 52 is set to provide the frequency, which is set to be the specific frequency (i.e., the second specific frequency f2) different from the stored specific frequency stored as the set frequency in the non-volatile setup storing unit 55, according to the control signal from the associated equipment 40.

When the master device 20 performs periodically the frequency confirmation operation, the frequency corresponding table is rewritten so as to connect the slave device 31a and the second specific frequency f2. Thus, after that, the communication and the energization between the slave device 30a and the master device 20 are performed with using the second specific frequency f2.

Thus, since the non-volatile setup storing unit 55 stores the set frequency, when the slave device 31 in the stop state is required to communicate with the master device 20, the slave device 31 is switched from the stop state to the active state according to the request from the associated equipment 40. Thus, the designing degree of freedom in the communication system 2 is improved.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication system comprising:
a master device; and
a plurality of slave devices, each of which communicates with the master device via a transmission line,
wherein the master device includes:
an electric power supply unit for selecting one of a plurality of specific frequencies, each of which is associated with one or more slave devices, and for outputting an electric power supply signal having the one of the specific frequencies to the transmission line;
a master communication unit for communicating with each slave device via the transmission line through a communication signal having a predetermined communication frequency; and
an electric power supply frequency setting unit for setting the one of the specific frequencies, which corresponds to a communication object slave device as a communication object of the master communication unit, and
wherein each slave device includes:
an electric power supply signal input and output unit for retrieving the electric power supply signal having a set frequency from the transmission line without contacting the transmission line, the set frequency being defined by a corresponding one of the specific frequencies associated with the slave device;
a communication signal input and output unit for receiving and transmitting the communication signal to the transmission line without contacting the transmission line;
a slave communication unit for communicating with the master device through the communication signal; and
a power source for energizing the slave communication unit according to the electric power supply signal, which is retrieved by the electric power supply signal input and output unit.

2. The communication system according to claim 1,
wherein the electric power supply signal input and output unit changes the set frequency to another one of the plurality of specific frequencies,
wherein the slave device further includes:
a setup switching and storing unit for switching the set frequency from the one of the specific frequencies to the another one of the specific frequencies, and for storing a setup that the set frequency is switched to the another one of the specific frequencies; and
a set frequency changing unit for controlling the setup switching and storing unit to change the setup when the slave communication unit receives an instruction, for changing the set frequency, from the master device.

3. The communication system according to claim 2,
wherein the slave communication unit functions when an electric power supply voltage from the power source maintains to be equal to or higher than a predetermined first threshold value, and
wherein the setup switching and storing unit functions when the electric power supply voltage from the power source maintains to be equal to or higher than a predetermined second threshold value, which is lower than the predetermined first threshold value.

4. The communication system according to claim 1,
wherein the electric power supply input and output unit and the communication signal input and output unit are combined with each other.

5. The communication system according to claim 4,
wherein the communication frequency is equal to the set frequency, which is set in the communication object slave device.

6. The communication system according to claim 1,
wherein the transmission line includes a connection portion having a shape, which provides a magnetic field, and
wherein each slave device is arranged at the connection portion of the transmission line.
